(19) United States
(12) Patent Application Publication
(10) Pub. No.: US 2014/0141176 A1
(43) Pub. Date: May 22, 2014

(54) NANOPARTICLE-ONLY LAYER BY LAYER SURFACE MODIFICATION OF SUBSTRATE MEMBRANE

(71) Applicant: The Trustees of Columbia University in the City of New York, New York, NY (US)

(72) Inventors: Christopher Durning, New York, NY (US); Luis Escobar-Ferrand, New York, NY (US)

(73) Assignee: The Trustees of Columbia University in the City of New York, New York, NY (US)

(21) Appl. No.: 14/115,190

(22) PCT Filed: May 1, 2012
(86) PCT No.: PCT/US12/35976

§ 371 Date: Jan. 23, 2014

Related U.S. Application Data
(60) Provisional application No. 61/481,496, filed on May 2, 2011.

(51) Int. Cl. C02F 1/44

(52) U.S. Cl. CPC C02F 1/44
USPC 427/470; 118/621

(57) ABSTRACT

Method and system for fabricating a thin film composite including providing a porous polymeric substrate membrane having a surface. At least one polyelectrolyte later can be deposited onto the surface of the substrate membrane, which can impart a charge to the surface. The substrate membrane can be immersed into a bath including a nanoparticle solution, thereby depositing at least one nanoparticle-only layer on the substrate membrane to form a thin film composite.

### CROSS-REFERENCE TO RELATED APPLICATIONS

This application is related to U.S. Provisional Application Ser. No. 61/481,496, filed May 2, 2011, which is incorporated herein by reference in its entirety and from which priority is claimed.

### BACKGROUND

The presently disclosed subject matter relates to systems and methods for modification of substrate membranes, including microfiltration and ultrafiltration membranes by depositing nanoparticles layer by layer on the substrate membrane.

Membranes can act as a unique solution for many separation requirements acting as an interphase, governed by different driving forces, and a selective barrier between two adjacent phases, regulating the transport of substances between the two compartments. One application for membranes is water purification. Physical water scarcity—characterized by severe environmental degradation, declining groundwater, and water allocations that favor some groups over others—is a growing problem around the world. In some regions, the stress on water resources is severe. Water withdrawals are high in arid and semi-arid lands, where they are needed for irrigation, and lower in tropical countries. Wastewater reuse and sea water desalination have emerged as foci of research to address these growing problems and several improvements through membrane technologies have been achieved. Examples include the membrane bioreactor (MBR) and the active integrated desalination membrane process system through hollow fiber micro/ultrafiltration and reverse osmosis (MF/RO).

Water Nano-filtration, often referred to as “low pressure RO membrane” nano-filtration, is a filtration process which can be applied to brackish water found, e.g., in surface and ground water streams. Water nano-filtration can soften brackish water and remove disinfection by-product (DBP) precursors and/or natural organic matter (NOM). The transmembrane pressure (TMP) required (which can be between about 50 psi and 150 psi) can be lower than those used for RO membranes (which can be between about 300 psi and 1200 psi). However, NF membranes can still be subject to scaling and fouling, and modifiers such as anti-scalants can be required for use.

Reverse Osmosis technology has been used for water demineralization for decades. Although effective, RO can be expensive and difficult to control. Further, certain RO membranes, based on polyamides, can exhibit little or no resistance to typical process chemicals and low recovery.

Accordingly, there remains a need for improved generation of membrane separation composites.

### SUMMARY

In accordance with one aspect of the disclosed subject matter, a method for fabricating a thin film composite having a porous polymeric substrate membrane is provided. At least one polyelectrolyte layer can be deposited onto the surface of the substrate membrane, which can impart a charge to the surface. The substrate membrane can be immersed into a bath including a nanoparticle solution, thus depositing at least one nanoparticle-only layer on the substrate membrane to form a thin film composite.

In one embodiment, the substrate membrane can be a microfiltration membrane or an ultrafiltration membrane. The substrate membrane can be, for example, polycarbonate track etched, polyethersulfone, sulfonated polyethersulfone membranes, or sulfonated poly etherethersulfone.

The polyelectrolyte layer can be deposited by immersing the substrate membrane in a cationic PAH solution, rinsing the substrate membrane, and immersing the substrate membrane in an anionic PAA solution. This can be repeated to deposit 2.5 bi-layers of polyelectrolyte coating, one layer being a PAH layer.

Deposition of the nanoparticle layer can be accomplished by immersing the substrate membrane in a first bath including anionic nanoparticles, rinsing the substrate membrane, immersing the substrate membrane in a second bath including cationic nanoparticles to form a bi-layer, and rinsing the substrate membrane again. This can be sequentially repeated to deposit a predetermined number of bi-layers. The anionic nanoparticles can be, for example, spherical anionic silica nanoparticles or elongated anionic silica nanoparticles. The cationic nanoparticles can be, for example, spherical cationic silica nanoparticles

In accordance with another aspect of the disclosed subject matter, a system for fabricating a thin film composite having a porous polymeric substrate membrane is disclosed. At least one vessel containing a polyelectrolyte solution can be included for depositing at least one polyelectrolyte layer to the surface of the substrate membrane, thereby imparting a charge to the surface. At least one vessel containing a nanoparticle solution can be included for immersing the substrate into a bath comprising a nanoparticle solution, thereby depositing at least one nanoparticle-only layer on the substrate membrane to form a thin film composite.

In one embodiment, the system can include at least a first vessel and a second vessel for containing polyelectrolyte solution, the first vessel containing cationic PAH solution and the second vessel containing anionic PAA solution. Additionally, the system can include at least a first vessel and a second vessel for containing nanoparticle solutions, the first vessel containing cationic nanoparticles and the second vessel containing anionic nanoparticles. A programmable robotic dipper having a dipping basket adapted to receive the substrate membrane can be configured to sequentially alternate immersing the dipping basket into the first and second vessels for containing polyelectrolyte solution, and configured to sequentially alternate immersing the dipping basket into the first and second vessels for containing nanoparticle solution.

### BRIEF DESCRIPTION OF THE DRAWINGS

It will be noted here that for a better understanding, like components are designated by like reference numerals throughout the various figures.

FIG. 1 is a flow diagram of a method for fabricating a thin film composite according to an embodiment of the disclosed subject matter.

FIG. 2 is a schematic diagram of a system for fabricating a thin film composite according to and embodiment of the disclosed subject matter.

FIG. 3 is a schematic diagram illustrating layer by layer deposition of nanoparticles according to an embodiment of the disclosed subject matter.

FIG. 4 is a schematic representation of glass slide disposition using binder clip clamps and wire according to an embodiment of the disclosed subject matter.

FIG. 5 is a top view scanning electron microscope image of various substrate membranes for use in accordance with an embodiment of the disclosed subject matter.

FIG. 6 is a cross-sectional scanning electron microscope image of various substrate membranes modified with layer by layer deposition of polyelectrolytes only.

FIG. 7 shows scanning electron microscope images of thin film composites fabricated according to embodiments of the disclosed subject matter.

FIG. 8 illustrates the relationship between the thickness profile of a nanoparticle only layer and the number of bi-layers fabricated according to an embodiment of the disclosed subject matter.

FIG. 9 is a chart demonstrating the filtration spectra.

### DETAILED DESCRIPTION

The presently disclosed subject matter relates to systems and methods for modification of substrate membranes. More particularly, the presently disclosed subject matter relates to systems and methods for modification of microfiltration and ultrafiltration membranes by depositing nanoparticles layer by layer on the substrate membrane.

As used herein, the term “brackish water” refers to water with total dissolved solids (TDS) between 1,000 and 10,000 mg/L.

As used herein, the term “microfiltration membranes” (“MF membranes”) refers to a membrane with a pore size on the order of micrometers. For example, a microfiltration membrane can have a pore size in the range of about 0.1 to 10 μm.

As used herein, the term “ultrafiltration membranes” (“UF membranes”) refers to a membrane with a pore size suitable to prevent macromolecular solutions from passing through the membrane. For example, an ultrafiltration membrane can be impermeable to molecules having an atomic mass unit of between 10³ and 10⁶ Da. That is, an ultrafiltration membrane can have a pore in the range of about 0.001 to 0.1 microns.

As used herein, the term “nano-filtration membranes” (“NF”) refers to membranes with a pore size on the order of nanometers. For example, a nano-filtration membrane can have a pore size below about 100 nm. NF membranes are often rated by molecular weight cutoff, and can have a molecular weight cut-off of less than 1000 Da.

As used herein, the term “reverse osmosis” (“RO”) refers to a process by which particular molecules and ions are removed from solution by applying pressure to the solution on one side of a selective membrane. That is, the solute is retained on the pressurized side of the membrane and the solvent is allowed to pass to the other side. It will be appreciated by those skilled in the art that this approach can also apply to NF, but RO operations can, for example, be operated at higher pressures.

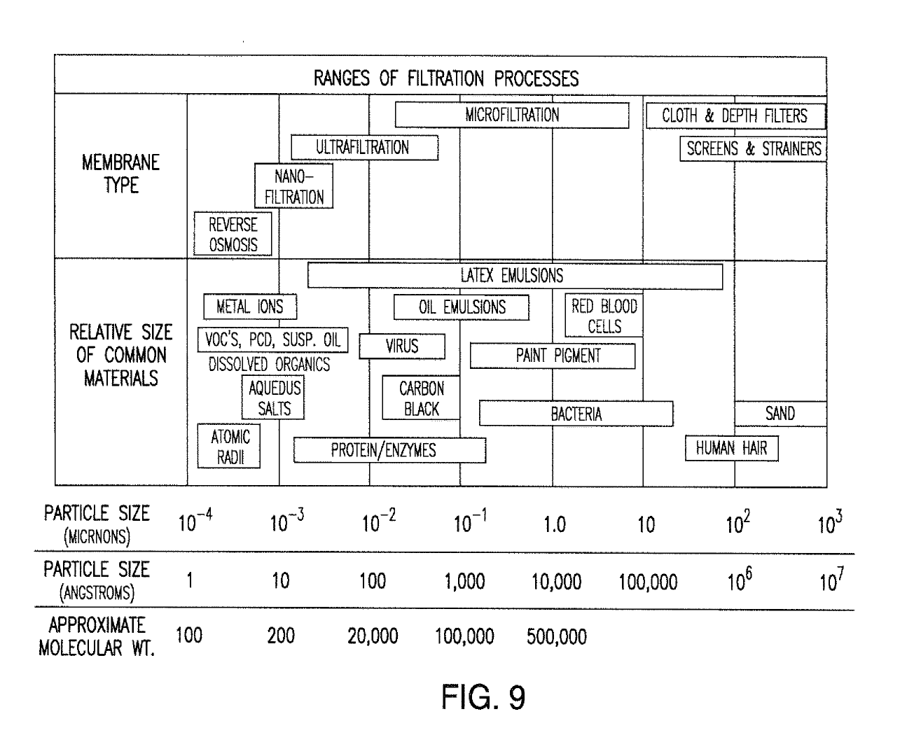

As demonstrated in FIG. 9, the terms RO, NF, UF, and MF can overlap in certain ranges. That is, there is not a unique definition of size range for every membrane filtration process. FIG. 9 provides an example of a filtration spectra, with membranes spanning an approximate range of both particle size and approximate molecular weight. FIG. 9 also provides examples of the relative size of comment materials.

As used herein, the term “thin film composite” (“TFC”) refers to a multi-layer film including of a porous nonselective support layer combined with a thin selective barrier multi-layer. The thin selective barrier multi-layer can be referred to as a “skin layer” or a “surface layer.” As disclosed herein, the selective barrier layer can be a nanoparticle layer.

While the presently disclosed subject matter will be described with reference to exemplary embodiments, the description is illustrative of the disclosed subject matter and is not to be construed as limiting. Various modifications to the presently disclosed subject matter can be made to the preferred embodiments by those skilled in the art without departing from the true spirit and scope of the disclosed subject matter as defined by the appended claims.

In accordance with one aspect of the disclosed subject matter, a method for fabricating a thin film composite includes providing a porous polymeric substrate membrane having a surface. At least one polyelectrolyte later can be deposited onto the surface of the substrate membrane, which can impart a charge to the surface. The substrate membrane can be immersed into a bath including a nanoparticle solution, thereby depositing at least one nanoparticle-only layer on the substrate membrane to form a thin film composite.

In accordance with another aspect of the disclosed subject matter, a system for fabricating a thin film composite includes a porous polymeric substrate membrane having a surface. At least one vessel containing a polyelectrolyte solution can be included for depositing at least one polyelectrolyte layer to the surface of the substrate membrane, thereby imparting a charge to the surface. At least one vessel containing a nanoparticle solution can be included for immersing the substrate into a bath comprising a nanoparticle solution, thereby depositing at least one nanoparticle-only layer on the substrate membrane to form a thin film composite.

Particular embodiments of these aspects of the disclosed subject matter are described below, with reference to the figures, for purposes of illustration, and not limitation. For purposes of clarity, embodiments of the method and system are described concurrently and in conjunction with each other.

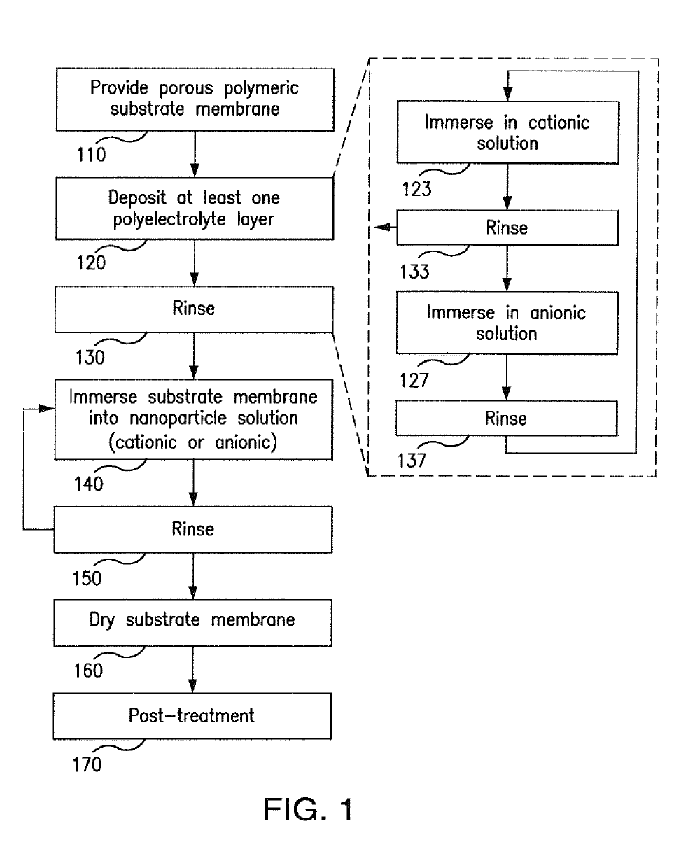

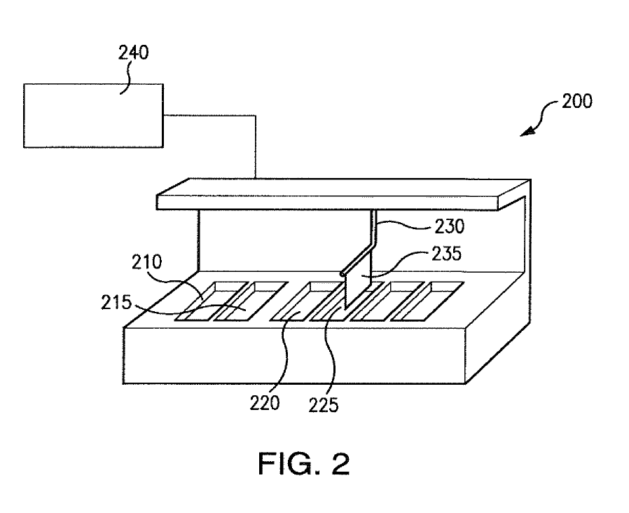

A method and system for fabricating a thin film composite according to the disclosed subject matter will now be described, for purposes of illustration and not limitation, with reference to FIG. 1 and FIG. 2. A porous polymeric substrate membrane can be provided (110). The substrate membrane can include of a variety of suitable materials having a variety of suitable configurations. For example, the substrate membrane can include a polymeric material configured as a flat sheet, hollow fibers, tubular configuration, cassettes, or the like. For example, in some embodiments, the substrate membrane can be a flat sheet membrane substrate. The pore size of the substrate membrane can be selected according to desired characteristics. For example, the pore size can be in a range associated with microfiltration and ultrafiltration. In an exemplary embodiment, the pore size can be in the range of about 100 to about 200 nm. In one embodiment, the porous polymeric substrate membrane can be a microfiltration membrane. In another embodiment, the porous polymeric substrate can be an ultrafiltration membrane.

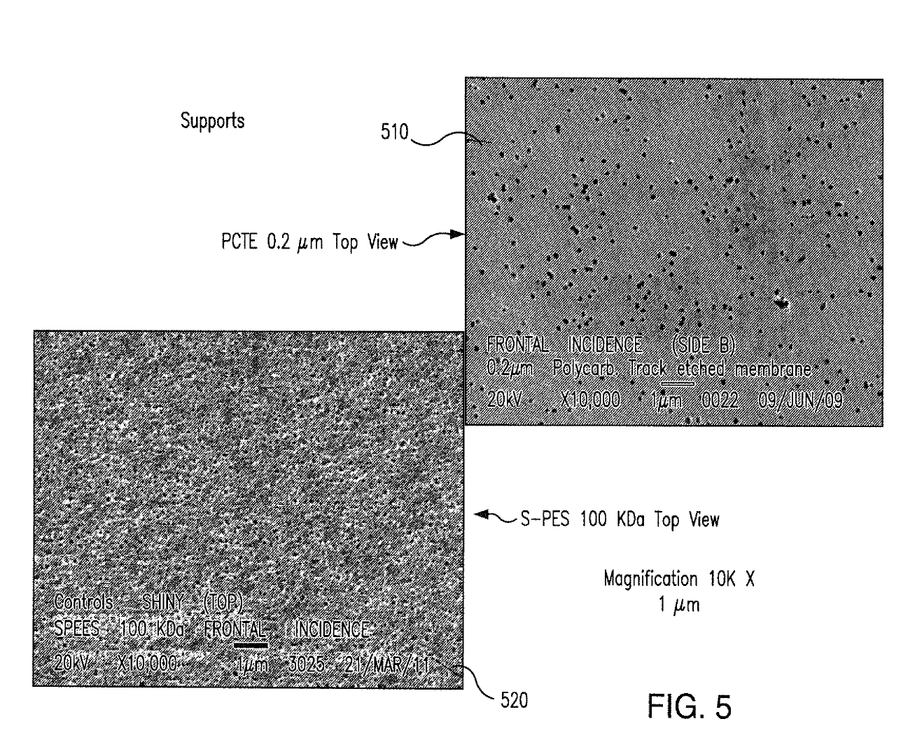

The substrate membrane can include, for example, polycarbonate track etch (PCTE), polyethersulfone (PES), sulfonated PES (s-PES), or sulfonated poly etherethersulfone (SPEES). In some embodiments, the substrate membrane can be a PCTE membrane a particular pore size, including 0.03, 0.05, 0.08, 0.1, and 0.2 μm. Alternatively, the substrate membrane can be PES having a particular pore size and can be characterized by molecular weight cutoff, including 100, 300, 500 and 1000 KDa. Alternatively, the substrate membrane can be Nylon AN-15 or AN-25 membranes or SPEES 10 or 100 KDa. Many substrate membranes are commercially available, from companies such as Millipore, Whatman and Pall Corporation. The substrate membrane can, for example, exhibit moderate hydrophobicity. FIG. 5 shows two exemplary substrate membranes. For example, the substrate membrane can be PCTE having a 0.2 μm pore size 510. Alternatively, the substrate membrane can be s-PES having a 100 KDa molecular weight cutoff 520. The substrate membrane can, for purposes of example, be alternatively be composed of polyvinylidene difluoride (PVDF), polyacrylonitrile (PAN), Polyetrafluoroethylene (PTFE), polypropylene (PP), or the like.

A thin film composite can be fabricated by depositing a selective barrier layer on a surface of the substrate membrane with Layer by Layer (“LbL”) deposition. Generally, the LbL process can include dipping a charged (e.g., cationic) substrate into a dilute aqueous solution of an anionic polyelectrolyte and allowing the polymer to adsorb and reverse the charge of the substrate surface. The negatively charged coated substrate can be rinsed to eliminate the charge excess and dipped into a solution of cationic polyelectrolyte, which can adsorb and recreate a positively charged surface. Sequential alternating adsorptions of anionic and cationic polyelectrolytes can allow the construction of multilayer films.

According to one embodiment of the disclosed subject matter, at least one polyelectrolyte layer can be deposited (120) onto the surface of the substrate membrane, which can impart a charge onto the surface of the membrane. This can be accomplished, for example, by immersing the substrate membrane into a vessel 210 containing a polyelectrolyte solution. As the substrate membrane is immersed, a polyelectrolyte layer can be formed on the surface of the substrate membrane. After immersion, the substrate membrane can be rinsed (130), for example in deionized water (DI).

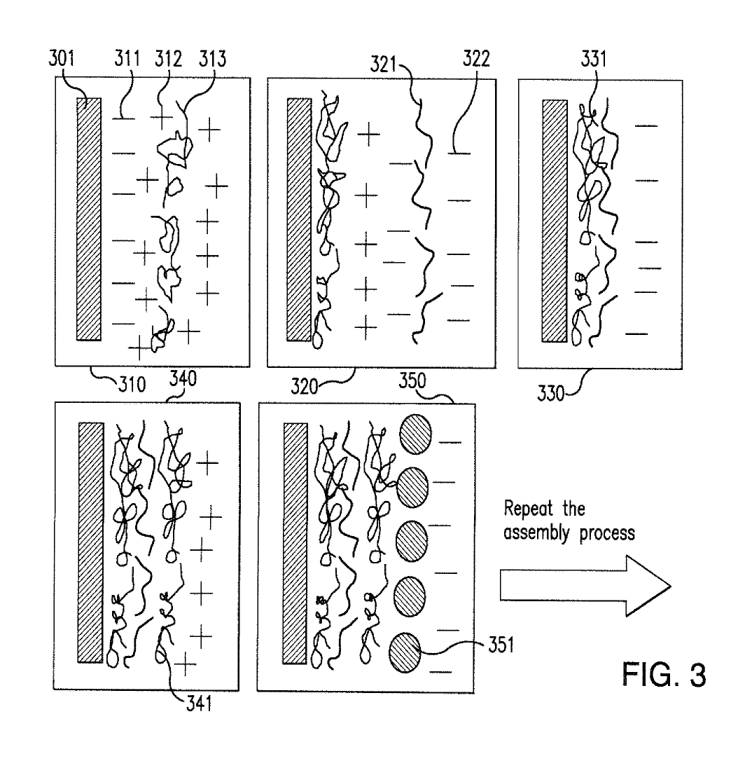

For purpose of illustration, and not limitation, deposition of a polyelectrolyte layer in accordance with an exemplary embodiment will now be described in detail with reference to FIG. 1, FIG. 2, and FIG. 3. One of ordinary skill in the art will recognize that there exist many suitable variations, and this description is not limiting. In an exemplary embodiment, a negatively charged 311 substrate membrane 301 can first be immersed in a cationic Poly(allylamine hydrochloride) (“PAH”) solution (123). PAH can have a molecular weight of 56,000 Da, and the PAH solution can be approximately 0.9357 g/L of PAH in DI water adjusted to pH 7.5. The PAH solution can be contained in a suitable vessel 210. The substrate membrane 301 can be immersed (123) in the PAH solution for approximately 10 minutes. The negative charge 311 of the substrate membrane 301 can cause the positively charged 312 cationic PAH 313 solution to adsorb and reverse the charge of the substrate membrane 301 surface.

After the substrate membrane is dipped or immersed (123) in the PAH solution, it can be rinsed (133) in DI water. For example, the substrate membrane can be rinsed twice in DI water—first for 2 minutes and then for 1 minute. Rinsing can be accomplished, for example, by immersing the substrate membrane in a suitable vessel containing DI water.

After the substrate membrane is rinsed (133), it can be immersed in an anionic Poly(acrylic acid) (“PAA”) solution (127). PAA can have a molecular weight of 100,000 Da, and can be approximately 35% solution in water. For example, the PAA solution can be prepared by dissolving 2.059 g/L of PAA in DI water and then adjusted to a pH of 3.5. The PAA solution can be contained in a suitable vessel 215. The substrate membrane can be immersed (127) in the PAA solution for approximately 10 minutes. The positive charge 313 of the substrate membrane 301 resulting from immersion in the cationic PAH solution can cause negatively charged anionic PAA 321 solution to adsorb and reverse the charge 322 of the substrate membrane 301 surface again.

After the substrate membrane is dipped or immersed (127) in the PAA solution, it can be rinsed (137) in DI water. For example, the substrate membrane can be rinsed twice in DI water—first for 2 minutes and then for 1 minute. Rinsing can be accomplished, for example, by immersing the substrate membrane in a suitable vessel containing DI water.

At this point, a bi-layer 331 of polyelectrolyte coating can be achieved. The process (123, 133, 127, 137) can be repeated until a predetermined number of bi-layers is achieved. In one embodiment, for example, 2.5 polyelectrolyte bi-layers 341 can be deposited on the substrate membrane surface to assure high surface charge density. In this embodiment, the process can stop during the third layer PAH immersion after the two DI water rinses. This can result in the surface of the substrate membrane being strongly positively charged, suitable for immersion in a solution of negative nanoparticles. One of ordinary skill in the art will appreciate that if positively charged nanoparticles are used, the process can be altered such that the process can stop after immersion in PAA and subsequent rinsing.

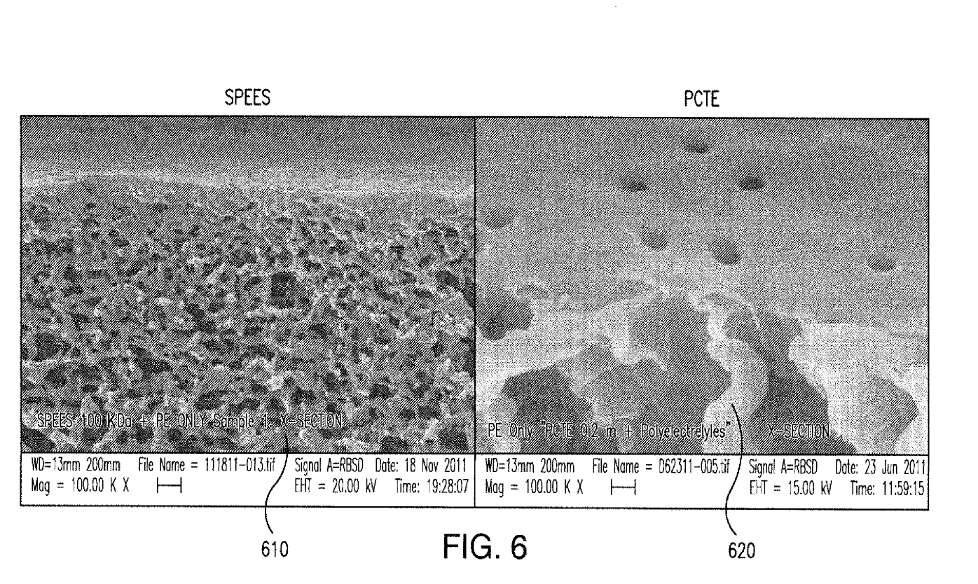

FIG. 6 is a cross-sectional scanning electron microscope image of various substrate membranes modified with layer by layer deposition of polyelectrolytes only. An SEM of SPEES 100 KDa 610 after deposition of 2.5 bi-layers of polyelectrolyte is shown in cross section. An SEM image of PCTE 0.2 μm 620 after deposition of 2.6 bi-layers of polyelectrolyte is also shown in cross section.

Again with reference to FIG. 1. and FIG. 2, the substrate membrane can be immersed (140) into a bath 220 including a nanoparticle solution, thereby depositing at least one nanoparticle-only layer on the substrate membrane to form a thin film composite. The bath 220 can be a vessel suitable for containing a nanoparticle solution.

In one embodiment, for example, the substrate membrane can be immersed (140) in a bath 220 of a solution of anionic nanoparticles. The anionic nanoparticles can be, for example, spherical silica nanoparticles or elongate silica nanoparticles. Additionally or alternatively, the substrate membrane can be immersed (140) in a bath 220 of a solution of cationic nanoparticles. For example, and not limitation, the nanoparticle solution can include Ludox® C1 colloidal spherical silica nanoparticles having a 30 wt % solution in water, or the nanoparticle solution can include Ludox® TM-40 colloidal spherical silica nanoparticles having a 40 wt % solution in water, both of which are commercially available from Sigma Aldrich. The nanoparticle solution can alternatively include Snowtex-UP colloidal elongated silica nanoparticles or Snowtex-OUP colloidal elongated silica nanoparticles, both of which are commercially available.

In some embodiments, the pH of the nanoparticle solution can be adjusted. For example, Hydrochloric Acid (HCL) and Sodium Hydroxide (NaOH) solutions can be used to adjust the pH.

As depicted schematically 350 in FIG. 3, for example, when a substrate membrane covered with a positively charged polyelectrolyte layer is immersed in the nanoparticle solution, the negatively charged anionic nanoparticles 351 adsorb and reverse the charge of the surface of the substrate membrane, thereby forming a nanoparticle-only layer. In one embodiment, the substrate membrane can be immersed (140) in nanoparticle solution for approximately 10 minutes.

Following immersion (140) in the nanoparticle solution, the substrate membrane can be rinsed. For example, it can be rinsed (150) in DI water. In some embodiments, the substrate membrane can be rinsed three times in DI water—first for 2 minutes, then for 1 minute, and then again for 1 minute. Rinsing can be accomplished, for example, by immersing the substrate membrane in a suitable vessel containing DI water. This process can be repeated to obtain a predetermined number of nanoparticle layers, for example with sequential immersion in cationic and anionic nanoparticle solutions. After a predetermined number of nanoparticle layers have been deposited, the substrate membrane can be dried (160).

For purpose of illustration, and not limitation, deposition of nanoparticle layers in accordance with an exemplary embodiment will now be described in detail with reference to FIG. 1, FIG. 2, and FIG. 3. One of ordinary skill in the art will recognize that there exist many suitable variations, and this description is not limiting. In an exemplary embodiment, a substrate membrane, being coated with 2.5 bi-layers of polyelectrolyte and having a positive charge, is first immersed in an anionic nanoparticle solution. The anionic nanoparticle solution can include, for example, Ludox C1 or Snowtex-UP, and the immersion can last for approximately 10 minutes. The substrate membrane can then be rinsed three times in DI water for 2 minutes, 1 minute, and one minute, respectively. The substrate membrane can then be immersed in a cationic nanoparticle solution. The cationic nanoparticle solution can include, for example, Ludox TM-40, and the immersion can likewise last for approximately 10 minutes. The same rinsing technique can be applied. At this point, one bi-layer of nanoparticles has been deposited. The sequence can be repeated until a desired number of bi-layers has been deposited, thereby forming a selective barrier layer. The selective barrier layer and the substrate membrane, collectively, comprise the thin film composite.

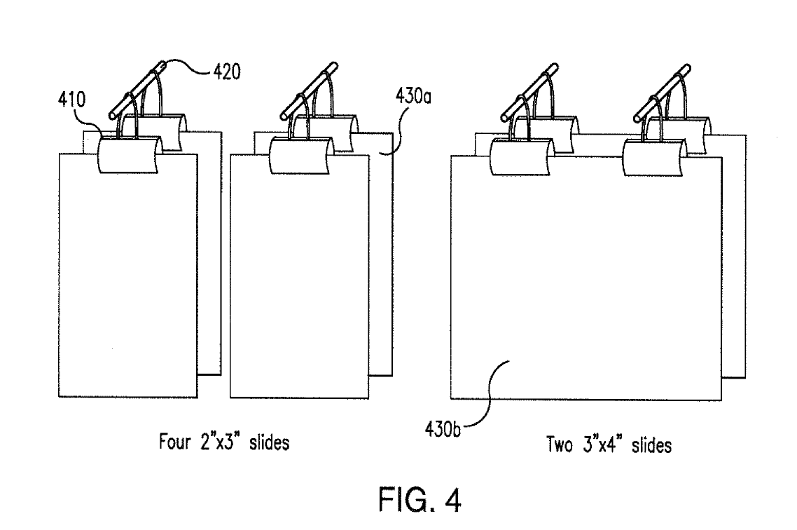

In some embodiments, the methods disclosed herein can be automated with the use of a programmable robotic dipper 200. For example, the programmable robotic dipper can include a dipping basket 235. The substrate membrane can be placed in the dipping basket 235. In some embodiments, as demonstrated in FIG. 4, flat sheet substrate membranes can be attached on glass slides 430. Glass slides can require at least 10 bi-layers of polyelectrolytes to adhere to membranes and be mounted securely. The last polyelectrolyte coat can be PAA (−). The glass slides 430 can be fastened to the dipping basket 235 with binder clips 410 and wire 420, which can allow for coating multiple slides at once. The membrane can be adhered to the slide by gently wet coating the membrane, which can be previously coated with 2.5 bi-layers of polyelectrolytes ending on a PAH(+) and rinsed with water, and placed on a coated slide. The membrane on the slide can then be dried.

Alternatively, the substrate membrane can be clapped in frames. The substrate membrane can be manipulated with a pair of anti-acid, anti-magnetic steel tweezers, and can be attached and stuck to a clean glass slide with a few drops of DI water. The glass slide can be aligned and centered with a slot made on the top half of a frame before closing. The closed frame can be secured and fixed with stainless steel binder clips, as demonstrated in FIG. 4. The binder clips can be positioned in a manner such that the required sealing to the frame is given without jeopardizing the absorption process. The sealed frames can then be placed in the dipper basket 235.

The programmable robotic dipper can have an arm 230 connected to the dipper basket 235 for translationally and/or rotationally manipulating the dipper basket 235. The dipper can include a control unit 240 which can be programmed to immerse the dipper basket 235 into a plurality of different vessels (210, 215, 220, 225), each of which contain a predetermined solution (e.g., polyelectrolyte solution or nanoparticle solution). In one embodiment, the programmable robotic dipper can be a Microns MS-50 Slide Stainer (commercially available from Zeiss) suitably adapted and programmed to perform techniques disclosed herein.

In one embodiment the thin film composite can undergo post-treatment processing (170). For example, the thin film composite can be heated, for example by placing the thin film composite in an autoclave operated at a wet autoclaving cycle at 121° C. for approximately one hour.

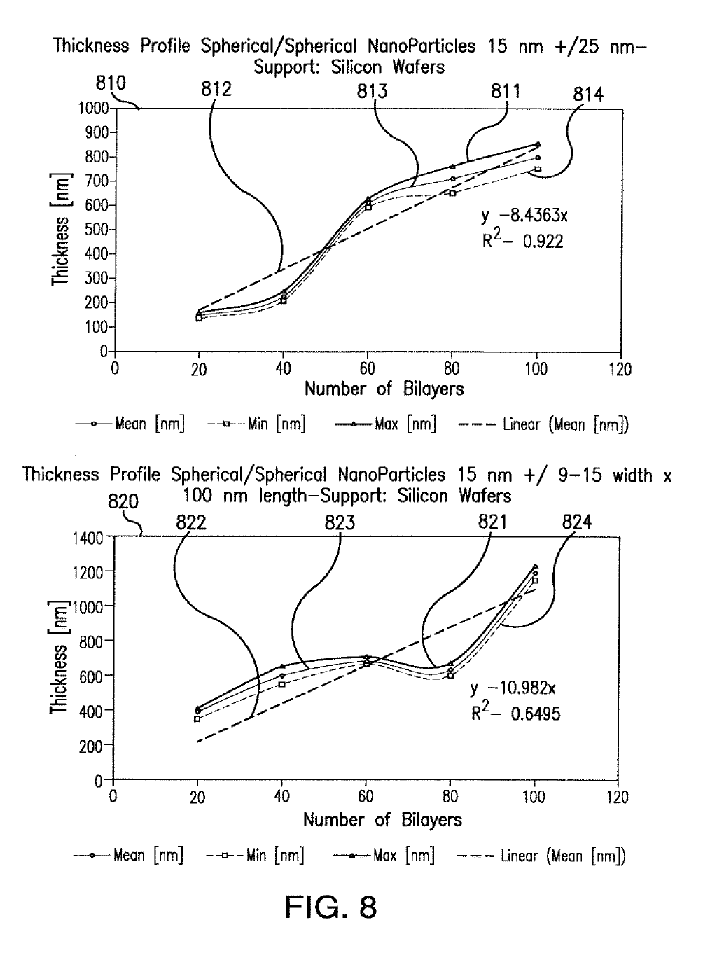

The techniques disclosed herein can allow for the fabrication of a thin film composite having a nanoparticle layer of arbitrary thickness (e.g., the number of nanoparticle bi-layers can be predetermined). The thickness of the nanoparticle layer varies monotonically with the number of bi-layers deposited. For example, as demonstrated in FIG. 8, a graph 810 of thickness versus number of bi-layers for spherical/spherical nanoparticles supported with silicon wafers shows the mean thickness 813, minimum thickness 814, maximum thickness 811, and mean thickness 812 in nanometers for 20, 40, 60, 80 and 100 bi-layers. Likewise, a graph 810 of thickness versus number of bi-layers for spherical/elongated nanoparticles supported on silicon wafers shows the mean thickness 823, minimum thickness 824, maximum thickness 821, and mean thickness 822 in nanometers for 20, 40, 60, 80 and 100 bi-layers. The graphs illustrate that thickness varies monotonically with the number of bi-layers. Additionally, the graphs illustrate that thickness for composites prepared with a spherical/elongated combination is larger relative to a spherical/spherical combination.

Cracks can occur in thin film composites fabricated according to the disclosed subject matter. For example, in many cases, cracks can run along the thickest (highest) regions of the nanoparticle layer. The geometric pattern in cracking can resemble patterns observed on colloidal systems. Hence, the cracks can correspond to drying induced cracks. Cracking can be mitigated by, inter alia, controlling the thickness of the nanoparticle layer. A thickness threshold limit can be determined for a thin film composite with a critical film thickness h_{c} with reference to:

$${h}_{c} = {{0.64 [ \frac{GM {φ}_{r} {R}^{3}}{2 γ} ]}^{1 / 2} [ \frac{2 γ}{- {P}_{m} R} ]}^{3 / 2} , \qquad ( 1 )$$

where G is the shear modulus of the particles, M is the coordination number, φᵣ is the particle volume fraction at random close packing, R is the particle radius, γ is the solvent air interfacial tension, and Pm is the maximum capillary pressure. As a result, the maximum theoretical thickness obtained for the thin film composites fabricated in accordance with the disclosed subject matter can be approximately 100 bi-layers,

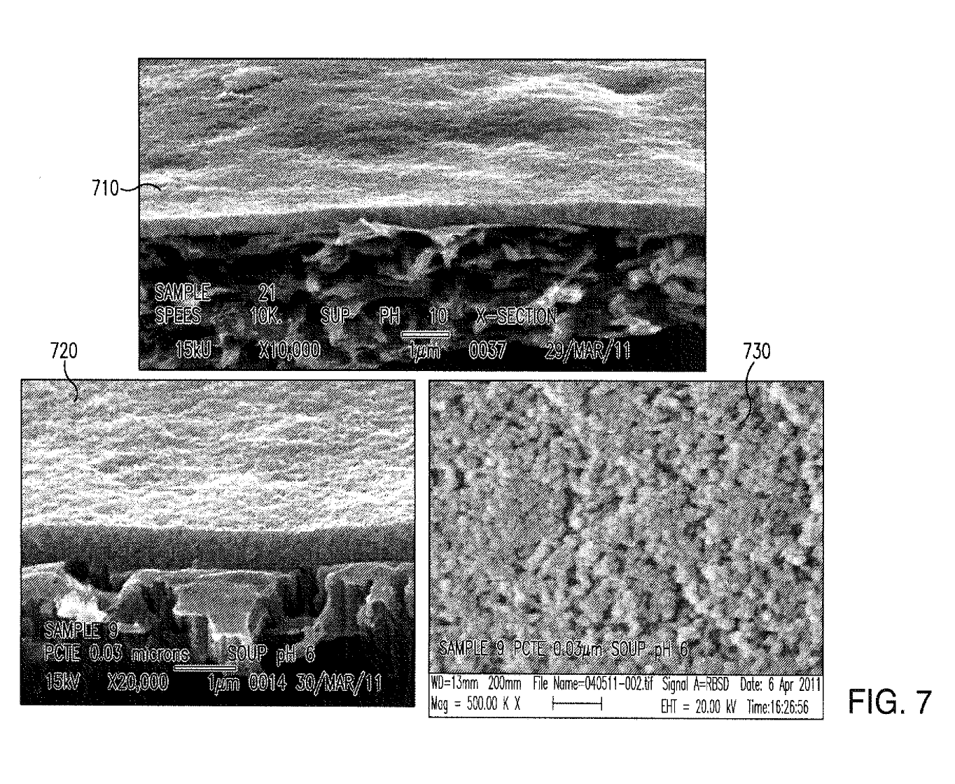

The techniques disclosed herein can provide high quality thin film composites, yielding a product which can have NF/RO membrane rejections levels for use with, inter alia, water purification applications. FIG. 7 shows scanning electron microscope images of thin film composites fabricated according to embodiments of the disclosed subject matter. As shown in the images, the thin film composites can have crack free nanoparticle layers 710, 720, and 730.

The presently disclosed subject matter is not to be limited in scope by the specific embodiments described herein. Indeed, various modifications of the disclosed subject matter in addition to those described herein will become apparent to those skilled in the art from the foregoing description and the accompanying figures. Such modifications are intended to fall within the scope of the appended claims.

1. A method for fabricating a thin film composite including a porous polymeric substrate membrane having a surface, comprising:
depositing at least one polyelectrolyte layer to the surface of the substrate membrane to impart a charge to the surface; and
immersing at least the charged surface of the substrate membrane into a bath comprising a nanoparticle solution to deposit at least one nanoparticle-only layer on at least a portion of the charged surface, thereby forming the thin film composite.

2. The method of claim 1, wherein the substrate membrane comprises a microfiltration membrane.

3. The method of claim 1, wherein the substrate membrane comprises an ultrafiltration membrane.

4. The method of claim 1, wherein the substrate membrane is selected from the group consisting of polycarbonate track etched, polyethersulfone, sulfonated polyethersulfone membranes, and sulfonated poly etherethersulfone.

5. The method of claim 1, wherein depositing at least one polyelectrolyte layer includes immersing the substrate membrane in a cationic Poly(allylamine hydrochloride) solution, rinsing the substrate membrane, and immersing the substrate membrane in an anionic Poly(acrylic acid) solution, thereby forming one bi-layer of polyelectrolyte coating.

6. The method of claim 5 further comprising sequentially alternating the immersing the substrate in cationic Poly(allylamine hydrochloride) solution and immersing the substrate membrane in anionic Poly(acrylic acid) solution to form 2.5 bi-layers of polyelectrolyte coating, wherein an outer layer is deposited by immersing the substrate membrane in a cationic Poly(allylamine hydrochloride) solution, and wherein the charge comprises a positive charge.

7. The method of claim 1, wherein the nanoparticle solution includes anionic nanoparticles.

8. The method of claim 1, wherein the nanoparticle solution includes cationic nanoparticles.

9. The method of claim 1, wherein the nanoparticle solution includes nanoparticles selected from the group consisting of spherical cationic silica nanoparticles, spherical anionic silica nanoparticles, and elongated anionic silica nanoparticles.

10. The method of claim 1, wherein the immersing further comprising:
(a) immersing at least the surface of the substrate membrane into a first bath including anionic nanoparticles;
(b) rinsing at least the surface of the substrate membrane;
(c) immersing at least the surface of the substrate membrane into a second bath including cationic nanoparticles, thereby forming a bi-layer of nanoparticle deposition; and
(d) rinsing at least the surface of the substrate membrane;

11. The method of claim 1, further comprising repeating (a) through (d) a predetermined number of times to form a corresponding predetermined number of bi-layers.

12. The method of claim 1, further comprising heating the thin film composite to dry the thin film composite.

13. The method of claim 1, further comprising maintaining the nanoparticle solution at a predetermined pH.

14. A system for fabricating a thin film composite including a porous polymeric substrate membrane having a surface, comprising:
at least one polyelectrolyte-solution vessel containing a polyelectrolyte solution and adapted to receive at least a portion of the porous polymeric substrate membrane, for depositing at least one polyelectrolyte layer to the surface of the substrate membrane, to thereby impart a charge to the surface thereof; and
at least one nanoparticle-solution vessel containing a nanoparticle solution and adapted to receive at least the charged surface of the substrate membrane therein, to thereby deposit at least one nanoparticle-only layer at least a portion of the charged surface of the substrate membrane to form a thin film composite.

15. The system of claim 14, further comprising a programmable robotic dipper having a dipping basket adapted to receive the substrate membrane, and configured to immerse the dipping basket into the polyelectrolyte-solution vessel and the nanoparticle-solution vessel.

16. The system of claim 15, wherein the at least one polyelectrolyte-solution vessel includes at least a first vessel and a second vessel, the first vessel containing a cationic Poly(allylamine hydrochloride) solution and the second vessel containing an anionic Poly(acrylic acid) solution, and wherein the programmable robotic dipper is configured to immerse the substrate membrane in the cationic Poly(allylamine hydrochloride) solution, immerse the substrate membrane in a rinsing vessel, and immerse the substrate membrane in an anionic Poly(acrylic acid) solution, thereby forming one bi-layer of polyelectrolyte coating.

17. The system of claim 15, wherein the at least one nanoparticle-solution vessel includes at least a first vessel and a second vessel, the first vessel containing a cationic nanoparticle solution and the second vessel containing an anionic nanoparticle solution, and wherein the programmable robotic dipper is configured to immerse the substrate membrane in the cationic nanoparticle solution, immerse the substrate membrane in a rinsing vessel, and immerse the substrate membrane in an anionic nanoparticle solution, thereby forming one bi-layer of polyelectrolyte coating.

18. The system of claim 14, wherein the nanoparticle solution comprises anionic nanoparticles.

19. The system of claim 14, wherein the nanoparticle solution comprises cationic nanoparticles.

20. The system of claim 14, wherein the nanoparticle solution includes nanoparticles selected from the group consisting of spherical cationic silica nanoparticles, spherical anionic silica nanoparticles, and elongated anionic silica nanoparticles.

21. The system of claim 15, wherein the substrate membrane is fastened to the dipping basket with at least one binding clip and at least one wire.

22. The system of claim 14, further comprising an autoclave for heating the thin film composite to dry the thin film composite.
